(19) United States
(12) Patent Application Publication
(10) Pub. No.: US 2021/0306300 A1
(43) Pub. Date: Sep. 30, 2021

(54) PORTABLE, HARDWARE-BASED AUTHENTICATION CLIENT TO ENFORCE USER-TO-SITE NETWORK ACCESS CONTROL RESTRICTIONS

(71) Applicant: Fortinet, Inc., Sunnyvale, CA (US)

(72) Inventors: Dorian Bodnariuc, Kanata (CA); Pingxiao Sheng, Kanata (CA)

(73) Assignee: Fortinet, Inc., Sunnyvale, CA (US)

(21) Appl. No.: 16/836,753

(22) Filed: Mar. 31, 2020

(51) Int. Cl. H04L 29/06

(52) U.S. Cl. CPC H04L 63/0272; H04L 63/0853; H04L 63/029; H04L 63/0876

(57) ABSTRACT

Systems and methods for a portable, hardware-based authentication client solution that enforces user-to-site network access control restrictions is provided. According to various embodiments of the present disclosure, the authentication client device maintains a list of pre-authorized client devices. The authentication client device is assigned to a particular user of an enterprise network and paired with a firewall appliance. A connection establishment request for establishing a connection with an enterprise network via the firewall appliance is received by the authentication client device via a network interface. The authentication client device confirms the connection establishment request was initiated by the particular user by authenticating the particular user. When the particular user is successfully authenticated, it is verified whether the client device is on the list of pre-authorized client devices. When the verification is affirmative, a connection is established between the authentication client device and the firewall appliance.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2020, Fortinet, Inc.

### BACKGROUND

### Field

Embodiments of the present invention generally relate to computer networking and network security. In particular, embodiments of the present invention relate to systems and methods for providing a portable, hardware-based authentication client for enforcing user-to-site network access control restrictions.

### Description of the Related Art

Software-based VPN solutions are widely used to enable client devices (e.g., laptop or desktop computer systems) to connect to corporate VPNs via on-site VPN/firewall appliances/gateways, for example. While software-based VPN solutions are easy to install and inexpensive to deploy, these solutions are limited in that they are operating system dependent and allow only a client device having an appropriate local agent installed to access the network. As such, to the extent a user needs multiple client devices to connect to a VPN, each client device requires its own installed VPN agent. Additionally, software-based VPN solutions cannot be used to facilitate VPN access on behalf of certain types of client devices, for example, a Voice over Internet Protocol (VoIP) phone on which third-party applications are not intended to be installed.

While hardware-based VPN gateways are available in the market and allow more than one device to connect to a VPN, these devices are not portable, are intended for deployment within a protected private network or a data center, for example, and are intended to be operated by skilled information technology (IT) professionals. Additionally, existing hardware-based VPN gateways do not offer device identity solutions.

### SUMMARY

Systems and methods are described for a portable, hardware-based authentication client solution that enforces user-to-site network access control restrictions. According to various embodiments of the present disclosure, a portable, hardware-based authentication client device maintains a list of pre-authorized client devices established by an administrator of an enterprise network. The portable, hardware-based authentication client device is assigned to a particular user of the enterprise network and paired with a firewall or VPN appliance associated with the enterprise network. The portable, hardware-based authentication client device receives from a client device via a wired or wireless network interface of the portable, hardware-based authentication client device, a connection establishment request for establishing a local or a VPN connection (depending upon the location of the client device) with the enterprise network via the firewall or VPN appliance. The portable, hardware-based authentication client device confirms that the connection establishment request was initiated by the particular user by authenticating the particular user. Further, when the particular user is successfully authenticated, it is verified whether the client device is on the list of pre-authorized client devices. In response to said verifying being affirmative, the portable, hardware-based authentication client device establishes a tunnel between the portable, hardware-based authentication client device and the firewall or VPN appliance

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an exemplary network architecture in which aspects of the present invention may be implemented in accordance with an embodiment of the present invention.

FIG. 2 is a block diagram illustrating functional components of an authentication client device in accordance with an embodiment of the present invention.

FIG. 3A is a block diagram illustrating various scenarios in the context of an unmonitored network in accordance with an embodiment of the present invention.

FIG. 3B is a block diagram illustrating various scenarios in the context of a monitored network in accordance with an embodiment of the present invention.

FIG. 4 is a flow diagram illustrating configuration and set up processing in accordance with an embodiment of the present invention.

FIG. 5 is a flow diagram illustrating a process of connecting remote client devices to an enterprise network via an authentication client device in accordance with an embodiment of the present invention.

FIG. 6 illustrates an exemplary computer system in which or with which embodiment of the present invention may be utilized.

### DETAILED DESCRIPTION

Systems and methods are described for a portable, hardware-based authentication client solution that enforces user-to-site network access control restrictions. According to one embodiment, an authentication client device may have a unique serial number for client device authentication and support a variety of multiple factor authentication methods, embedded on the device. For example, the authentication device may include a biometric security identification and authentication mechanism (e.g., a finger reader, voice recognition, face recognition, iris or retina recognition, or the like), support one or more Open Authentication (OATH) compliant, time-based One Time Password (OTP) generator applications (e.g., the FortiToken family of OTP generators available from the assignee of the present invention), and support third-party authentication (e.g., lightweight directory access protocol (LDAP) and remote authentication dial-in user service (RADIUS)). For additional security, the authentication device may be set up and configured by the IT team of the enterprise to which VPN access is to be provided and may be assigned to a particular user. Depending upon the VPN infrastructure implemented by the enterprise network, the authentication device may support one or more types of VPN connections, including secure sockets layer (SSL) VPN or IP Secure (IPSec) VPN. In one embodiment, multiple pre-authorized client devices (e.g., smartphones, VoIP phones, laptop computers, tablet computers, desktop computers, and the like) of a user can be concurrently securely connected through the authentication device to an enterprise network, for example, either via an embedded switch or an external switch. As described further below, in this manner, the authentication client device may be used to restrict access to an enterprise network. For example, if a user does not have such a device, the user cannot connect to the network; and, if the user does have such a device, the user can connect to the network, subject to network access control rules applied to the device.

According to one embodiment, the authentication device includes two modes of operation. For example, the authentication device may operate in a VPN mode, when the device is not within the enterprise network with which it is registered, and a may operate in a local mode, when the device is present in the enterprise network. In one embodiment, while in local mode, the authentication device may provide an extra security layer. For example, the local mode may protect very sensitive networks by preventing foreign computers from participating in the network. In one embodiment, any client device may be connected to the wired network of an enterprise network, but only those client devices connected to the wired network via an authentication device are allowed access to the internal network and resources associated therewith. For example, all other client devices connected to the wired network without the use of an authentication device may be denied access to the network completely, or routed to the Internet. Furthermore, the authentication devices may be routed and allowed specific access within the internal network according to the network administrators' specifications. In one embodiment, in local mode, various security features (e.g., anti-virus scanning features and/or port filtering) implemented by the authentication device may be used to disallow the client device from communicating on certain ports to protect the network against malware.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. Some network security devices may be implemented as general-purpose computers or servers with appropriate software operable to perform the one or more security functions. Other network security devices may also include custom hardware (e.g., one or more custom Application Specific Integrated Circuits (ASICs)). A network security device is typically associated with a particular network (e.g., a private enterprise network) on behalf of which it provides the one or more security functions. The network security device may reside within the particular network that it is protecting or network security may be provided as a service with the network security device residing in the cloud. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances, VPN/firewall appliances, VPN gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), and DoS attack detection appliances (e.g., the FORTIDDOS family of DoS attack detection and mitigation appliances).

As used herein “user-to-site” generally refers to an association between a user and a site. For example, an IT team of an enterprise may set up a number portable, hardware-based authentication devices for use by individual users of the enterprise network by forming pre-established or configured associations between the user and one or more sites within the enterprise network. In embodiments described herein, a portable, hardware-based authentication client may be referred to herein as a user-to-site VPN device as a result of being assigned to a particular user of an enterprise and associated with one or more VPN/firewall appliances of an enterprise network (e.g., a VPN appliance associated with a branch office network and/or a VPN appliance associated with a headquarters office network). In embodiments described herein, multiple devices (e.g., a laptop computer, a smartphone, a tablet computer, a desktop computer, etc.) of the user to which the user-to-site VPN device has been assigned may be connected through the user-to-site VPN device to a particular site of an enterprise network.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

Systems and methods are described for a portable, hardware-based authentication client solution that enforces user-to-site network access control restrictions. According to various embodiments of the present disclosure, a portable, hardware-based authentication client device maintains a list of pre-authorized client devices established by an administrator of an enterprise network. The portable, hardware-based authentication client device is assigned to a particular user of the enterprise network and paired with a firewall or VPN appliance associated with the enterprise network. The portable, hardware-based authentication client device receives from a client device via a wired network interface of the portable, hardware-based authentication client device, a connection establishment request for establishing a connection (e.g., a local connection or a VPN connection) with the enterprise network via the firewall or VPN appliance. The portable, hardware-based authentication client device confirms that the connection establishment request was initiated by the particular user by authenticating the particular user. Further, when the particular user is successfully authenticated, it is verified whether the client device is on the list of pre-authorized client devices. In response to said verifying being affirmative, the portable, hardware-based authentication client device establishes a tunnel between the portable, hardware-based authentication client device and the firewall or VPN appliance

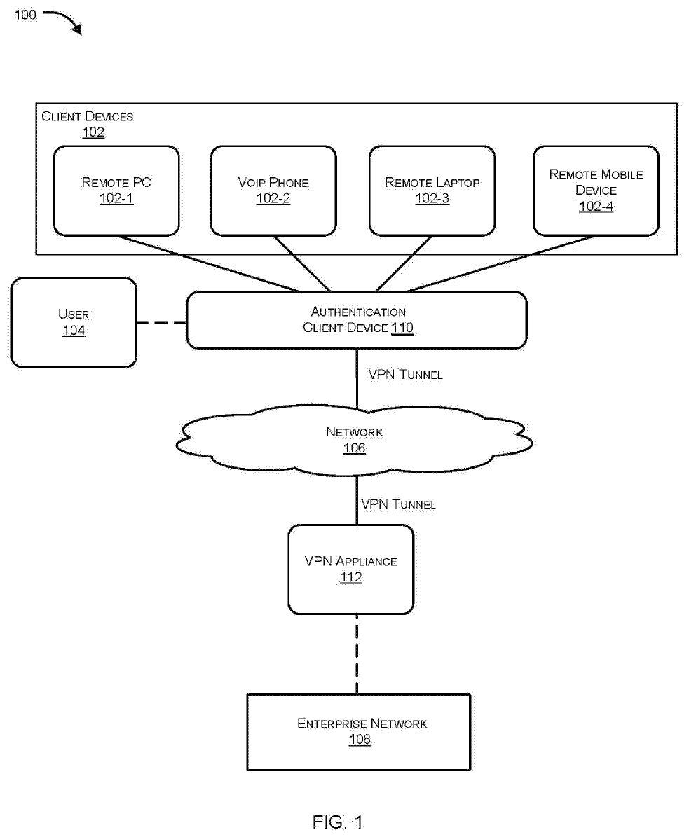

FIG. 1 is an exemplary network architecture 100 in which aspects of the present invention may be implemented in accordance with an embodiment of the present invention. In accordance with the present example, network architecture 100 includes various client devices (e.g., a remote PC 102-1, a VoIP phone 102-2, a remote laptop 102-3, and a remote mobile device 102-4 (which may be collectively referred to herein as client devices 102 and may be individually referred to herein as client device 102)) that may be associated with and used by a particular user (e.g., user 104) of an enterprise network (e.g., enterprise network 108).

In one embodiment, an authentication client device 110 (which may also be referred to herein as a portable, hardware-based authentication client device) is assigned to the user. For example, the authentication client device 110 may be assigned to a particular user 104 of enterprise network 108 by issuing a unique token (e.g., an OATH compliant token) to the authentication client device 110. The unique token may be used for authentication of the particular user of the enterprise network. The authentication client device 110 may also include an integrated biometric security identification and authentication mechanism (e.g., a finger reader, voice recognition, face recognition, iris or retina recognition, or the like) and be initialized with appropriate biometric samples from the user so as to establish a VPN connection between a client device 102 and a VPN appliance (e.g., VPN appliance 112) associated with the enterprise network only after confirming the user 104 initiated the connection. Further, the authentication client device 110 may be paired with one or more VPN appliances (e.g., VPN appliance 112) associated with the enterprise network.

In an embodiment, authentication client device 110 maintains a list of pre-authorized client devices 102 (e.g., remote PC 102-1, VoIP Phone 102-2, remote laptop 102-3, and remote mobile device 102-4). This list of pre-authorized client devices 102 may be established by an administrator of enterprise network 108, for example, by inputting their respective media access control (MAC) addresses and/or corresponding serial numbers.

During an initialization or registration process, authentication client device 110 may also be assigned to a particular user of enterprise network 108 and paired with a VPN appliance 112 (e.g., a VPN/firewall appliance) associated with enterprise network 108. For example, the authentication client device 110 may be authenticated via a unique device ID randomly generated at the first boot and the MAC address of the public interface of the VPN or firewall appliance. These values may then be communicated with the VPN/Firewall appliance 112 at the time of initial registration with the VPN/Firewall appliance 112. In one embodiment, the VPN/Firewall appliance records the device in its database, based on the device unique ID, MAC address, and/or device certificate. At this time, the authentication client device may also be assigned an initial configuration specific to the VPN/Firewall appliance. Then, the authentication client device will be assigned a set of rules specific to the user (e.g., Lightweight Directory Access Protocol (LDAP)/Active Directory (AD) account, OTP)

During this initial device registration, the authentication client device 110 may also be provided with the VPN/Firewall appliance unique device ID and IP addresses (e.g., public and private). Then, these unique numbers may be communicated during the authentication exchange, for mutual authentication. Those skilled in the art will appreciate, other device authentication methods may be used, for example, via a device certificate plus unique ID. Depending on the security requirements, the authentication device can be locked against further changes of the VPN/firewall appliance address, or the authentication device may allow changes to be pushed from the a management appliance (e.g., a FORTIMANAGER management appliance).

In one embodiment, responsive to receipt by the authentication client device 110 of a connection establishment request for establishing a VPN connection with enterprise network 108 via VPN appliance 112 via a network interface (e.g., a wired or wireless interface) of authentication client device 110, authentication client device 110 confirms whether the connection establishment request was initiated by user 104 by authentication of user 104 (e.g., via the a biometric security identification and authentication mechanism). When the user 104 is successfully authenticated, a further security check may be performed to determine whether the client device 102 is on the list of pre-authorized client devices. When the client device 102 is confirmed to be on the list of pre-authorized client devices, authentication client device 110 establishes a tunnel between authentication client device 110 and VPN appliance 112 through an intermediate network (e.g., network 106).

Network 106 may be a wireless network, a wired network or a combination thereof that can be implemented as one of the different types of networks, such as an Intranet, a Local Area Network (LAN), a Wide Area Network (WAN), the Internet, and the like. Further, network 106 may be a dedicated network or a shared network. A shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

In some embodiments, authentication client device 110 may operate in one of multiple modes, including a VPN mode and a local mode, and may support various types of VPN connections. For example, authentication client device 110 may operate in the VPN mode, when authentication client device 110 is not within (e.g., connected directly to) enterprise network 108 with which it is registered, and may operate in the local mode, when the authentication client device is present in enterprise network 108.

In one embodiment, while in the local mode, authentication device 110 may provide an extra security layer. For example, the local mode may protect very sensitive networks by preventing foreign computers from participating in enterprise network 108. In one embodiment, any client device 102 may be connected to wired network of an enterprise network 108, but only those client devices 102 connected to the wired network via an authentication client device are allowed access to the internal network and resources associated therewith. For example, all other client devices connected to the wired network without the use of an authentication client device may be routed to the Internet. Furthermore, authorized users of the enterprise network using their respective authentication client devices may be routed and allowed specific access within the internal network according to the network administrators' specifications.

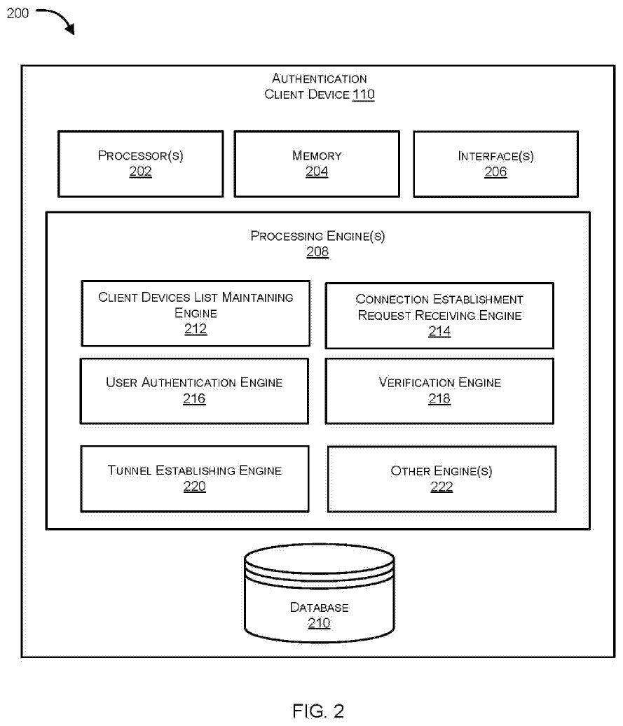

FIG. 2 is a block diagram 200 illustrating functional components of an authentication client device 110 in accordance with an embodiment of the present invention. In the context of the present example, authentication client device 110 can include one or more processor(s) 202. Processor(s) 202 can be implemented as one or more microprocessors, microcomputers, microcontrollers, digital signal processors, central processing units, logic circuitries, and/or any devices that manipulate data based on operational instructions. Among other capabilities, processor(s) 202 are configured to fetch and execute computer-readable instructions stored in a memory 204 of authentication client device 110. Memory 204 can store one or more computer-readable instructions or routines, which may be fetched and executed to create or share the data units over a network service. Memory 204 can include any non-transitory storage device including, for example, volatile memory such as RAM, or non-volatile memory such as EPROM, flash memory, and the like. In an example embodiment, memory 204 may be a local memory or may be located remotely, such as a server, a file server, a data server, and the Cloud.

Authentication client device 110 can also include one or more Interface(s) 206. Interface(s) 206 may include a variety of interfaces, for example, interfaces for data input and output devices, referred to as I/O devices, storage devices, and the like. Interface(s) 206 may facilitate communication of authentication client device 110 with various devices coupled to authentication client device 110. Interface(s) 206 may also provide a communication pathway for one or more components of authentication client device 110. Examples of such components include, but are not limited to, processing engine(s) 208 and database 210.

Processing engine(s) 208 can be implemented as a combination of hardware and software or firmware programming (for example, programmable instructions) to implement one or more functionalities of engine(s) 208. In the examples described herein, such combinations of hardware and software or firmware programming may be implemented in several different ways. For example, the programming for the engine(s) 208 may be processor executable instructions stored on a non-transitory machine-readable storage medium and the hardware for engine(s) 208 may include a processing resource (for example, one or more processors), to execute such instructions. In the examples, the machine-readable storage medium may store instructions that, when executed by the processing resource, implement engine(s) 208. In such examples, authentication client device 110 can include the machine-readable storage medium storing the instructions and the processing resource to execute the instructions, or the machine-readable storage medium may be separate but accessible to authentication client device 110 and the processing resource. In other examples, processing engine(s) 208 may be implemented by electronic circuitry. Database 210 can include data that is either stored or generated as a result of functionalities implemented by any of the components of processing engine(s) 208.

In an example, processing engine(s) 208 can include a client devices list maintaining engine 212, a connection establishment request receiving engine 214, a user authentication engine 216, a verification engine 218, a tunnel establishing engine 220 and other engine(s) 222. Other engine(s) 222 can implement functionalities that supplement applications or functions performed by authentication client device 110 or processing engine(s) 208.

According to an embodiment, client devices list maintaining engine 212 maintains a list of pre-authorized client devices established by an administrator of an enterprise network. Authentication client device 110 may be assigned to a particular user of the enterprise network and paired with a VPN appliance associated with the enterprise network. In one embodiment, connection establishment request receiving engine 214 receives a connection establishment request for establishing a VPN connection with the enterprise network via the VPN appliance. The request may be received by authentication client device 110 via a wired network interface of authentication client device 110. Upon receiving the request, authentication client device 110 confirms whether the connection establishment request was initiated by the particular user by authenticating the particular user using user authentication engine 216. Further, upon successful authentication of the particular user, verification engine 218 may perform a further verification to determine whether the client device is on the list of pre-authorized client devices. When the client device is confirmed to be on the list of pre-authorized client devices, tunnel establishing engine 220 establishes a tunnel between the authentication client device and the VPN appliance.

According to one embodiment, authentication client device 110 may be assigned to a particular user of the enterprise network by issuing a unique token to the authentication client, and the unique token may be used for authentication of the client device. The authentication client device 110 may operate in either a VPN mode or a local mode, and may support multiple type of VPN connections. Further, various client devices from the list of pre-authorized client devices may establish concurrent connections through authentication client device 110 to the enterprise network.

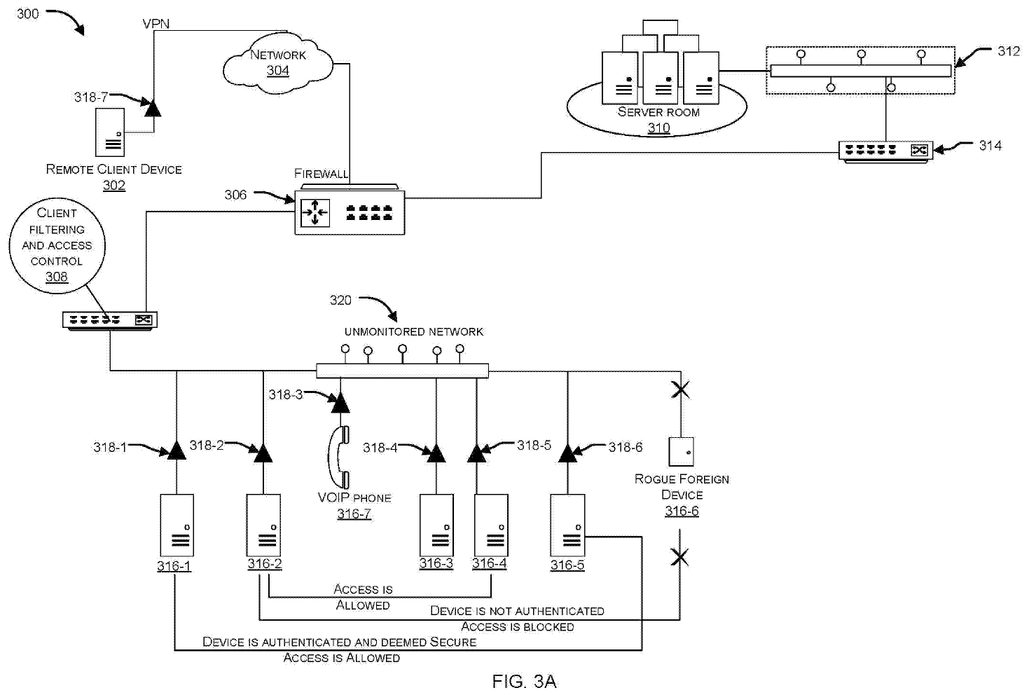

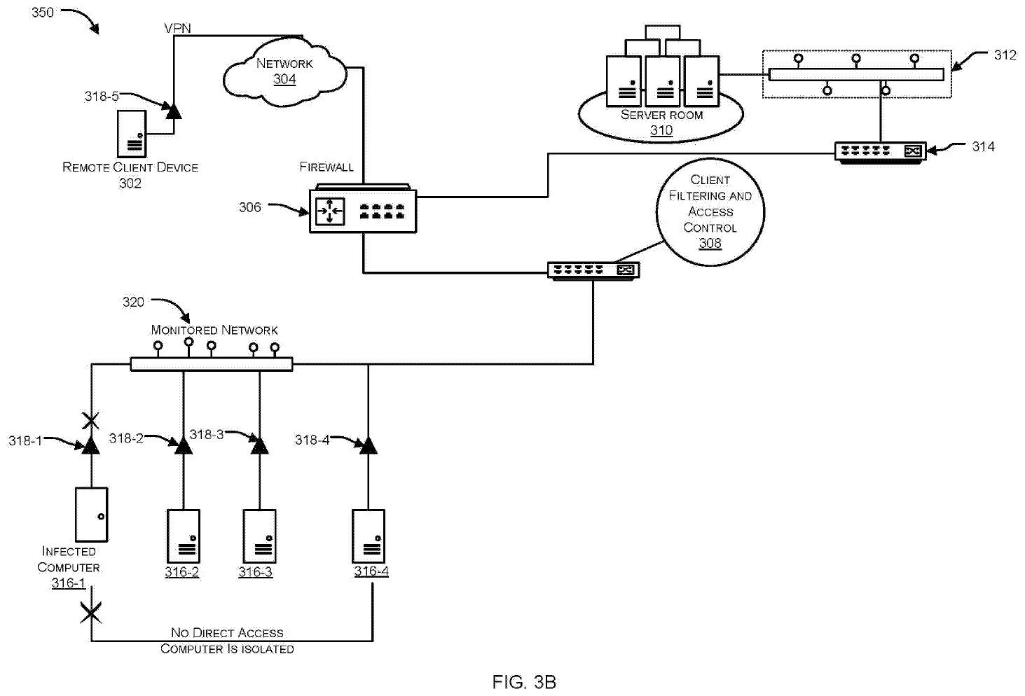

FIG. 3A is a block diagram 300 illustrating various scenarios in the context of an unmonitored network 320 in accordance with an embodiment of the present invention. In the context of the present example, a set of client devices 316-1, 316-2, 316-3, 316-4, 316-5, and 316-7 are coupled to the unmonitored network 320 via respective authentication client devices 318-1, 318-2, 318-4, 318-5, 318-6, and 318-3. According to one embodiment, authentication client devices 318-1, 318-2, 318-4, 318-5, 318-6, and 318-3 may be operating in local mode as they are directly connected to the private network with which they are registered, whereas authentication client device 318-7 associated with remote client device 302 may be operating in VPN mode as it is connected to the private network with which it is registered indirectly via network 304.

As those skilled in the art will appreciate, existing client filtering solutions are performed at the firewall level (e.g., by firewall appliance 306). In such an environment, a rogue computer (e.g., rouge foreign device 316-6) would be allowed to participate in the traffic within the switching domain of network switch 308 and may potentially gain access to sensitive information, or may even attempt to infiltrate malware into unprotected computers via the unmonitored network 320.

According to one embodiment, when any client device attempts to establish a connection with the unmonitored network 320, network switch 308 may act as a client filtering device, thereby precluding the rogue computer from exchanging traffic within the switching domain of network switch 308. For example, when a client device attempts to connect to the unmonitored network 320, network switch 308 may allow network communication by the client device on a preassigned dedicated virtual local area network (VLAN). In one embodiment, the preassigned dedicated VLAN is only allowed to communicate with a firewall appliance (e.g., firewall 306). The firewall appliance then verifies the identity of the client device. If the client device is not a recognized/authorized authentication client device the port through which the client device is communicating may be blocked preventing further communication. Alternatively, if the client device is a recognized/authorized authentication client device, the firewall appliance then verifies the identity of the user and may assign additional VLANs according to the predefined policy for the user, thus allowing the network access.

According to one embodiment, when one of the client devices attempts to make use of a resource associated with the unmonitored network 320, a client filtering and access control device 308 may permit or deny the requests based on whether the client device is connected to the unmonitored network 320 via an authentication client device that is registered with the client filtering and access control device 308. For example, access by client devices 316-1, 316-2, 316-3, 316-4, 316-5, and 316-7 may be allowed, whereas access by a rogue foreign device 316-6, attempting to access the unmonitored network 320 without an authentication client device is blocked.

Similarly, in the context of the present example, when a remote client device 302 via an associated authentication client device 318-7 makes a request to connect to unmonitored network 320 or to a resource within a server room 310 protected by a client filtering and access control device 314 via network 304, the request is passed through a router 306 equipped with a firewall. Further, filtering and access control of remote client device 302 may be performed by a client filtering and access control device (e.g., 308 or 314). Upon successful verification of remote client device 302 and of a user associated with remote client device 302, a connection is established between remote client device 302 and the desired network (e.g., unmonitored network 320 or network 312).

FIG. 3B is a block diagram 350 illustrating various scenarios in the context of a monitored network 320 in accordance with an embodiment of the present invention. In the context of the present example, while infected computer 316-1 is a legitimate participate in the monitored network 320 and was previously authenticated as such, its authentication client 318-1 has decided to block the communication from the infected computer 316-1 as a result of detection of malware by embedded real-time anti-virus scanning implemented by the authentication device 318-1. Those skilled in the art will appreciate, in this manner, an authentication device (e.g., authentication device 318-1) may be used to disallow a client device (e.g., infected computer 316-1) from communicating on certain ports to protect the network 320 against malware.

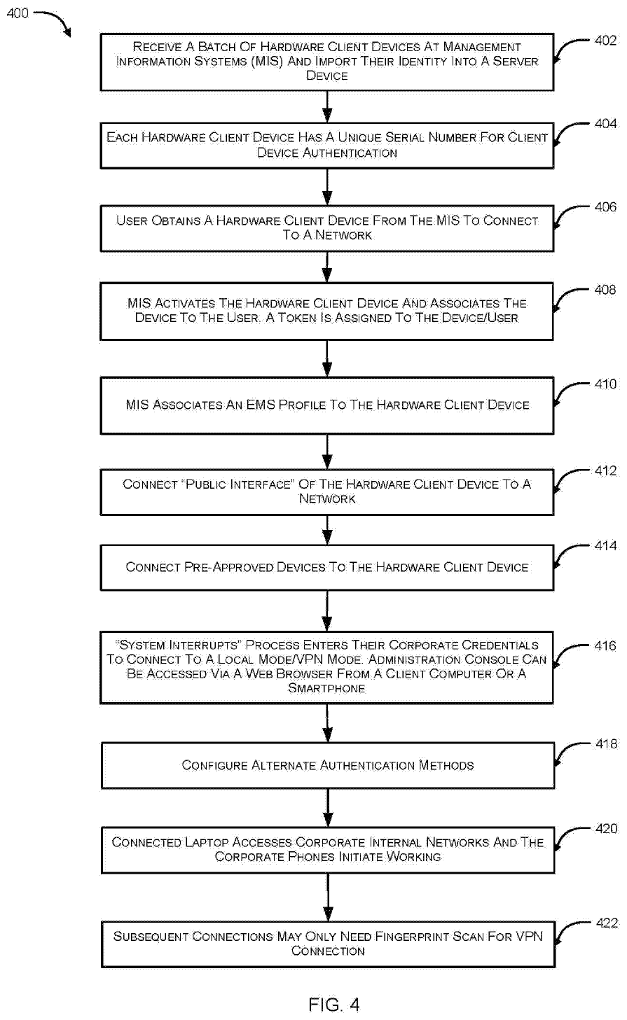

FIG. 4 is a flow diagram 400 illustrating configuration and set up processing in accordance with an embodiment of the present invention. As is illustrated, at block 402, a batch of hardware client devices (e.g., a batch of authentication client devices 110) is received at a Management Information Systems (MIS) group of an enterprise and identity of the hardware client devices is imported into a server device. For example, the tokens assigned to the respective users of the hardware client devices may be stored within the server device. At block 404, each of the hardware client devices may be assigned a unique serial number, for client device authentication. At block 406, a user may obtain a hardware client device from MIS to connect to a private network of the enterprise. At block 408, MIS may activate the hardware client device and associate the hardware device with the user. At this step, a token may be assigned to the device/user. At block 410, MIS may associate an enterprise management server (EMS) profile with the hardware client device. For example, the EMS profile may contain VPN information, information about approved participating devices of the user (e.g., a laptop, a VoIP phone, a smartphone, etc.) Further, at block 412, a “public interface” of the hardware client device is connected to the network and at block 414, the pre-approved devices may be connected to the hardware client device. At block 416, a “System Interrupts” process may enter corporate credentials to connect the hardware client device to either a VPN mode or a local mode. Further, an administration console may be accessed via a web browser from, for example, a client computer or a smartphone. At block 418, alternate authentication methods may be configured such as the user's fingerprints. Thereafter, at block 420, the registered devices (e.g., the user's laptop and corporate smartphone or VoIP phone) may access corporate internal networks. At block 422, after being configured in accordance with FIG. 4, subsequent connections may only need fingerprint scan for establishing a VPN connection.

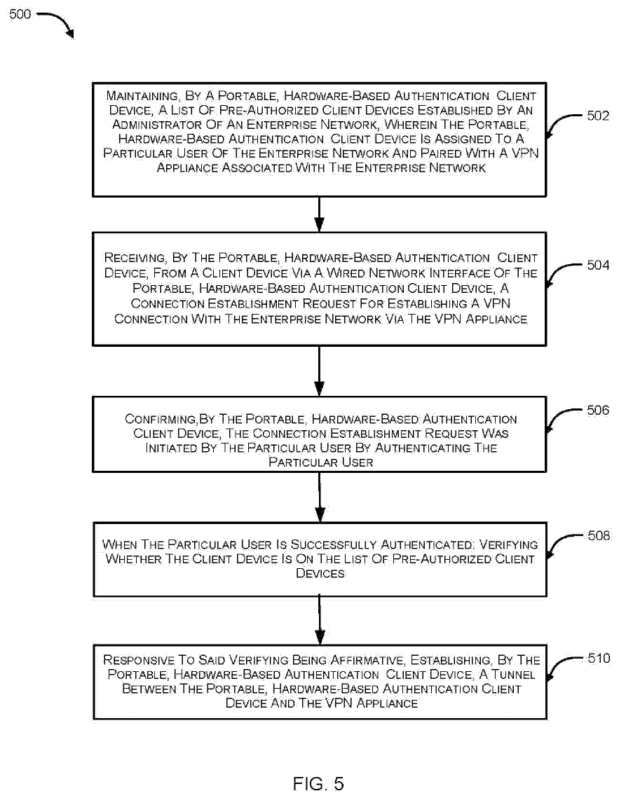

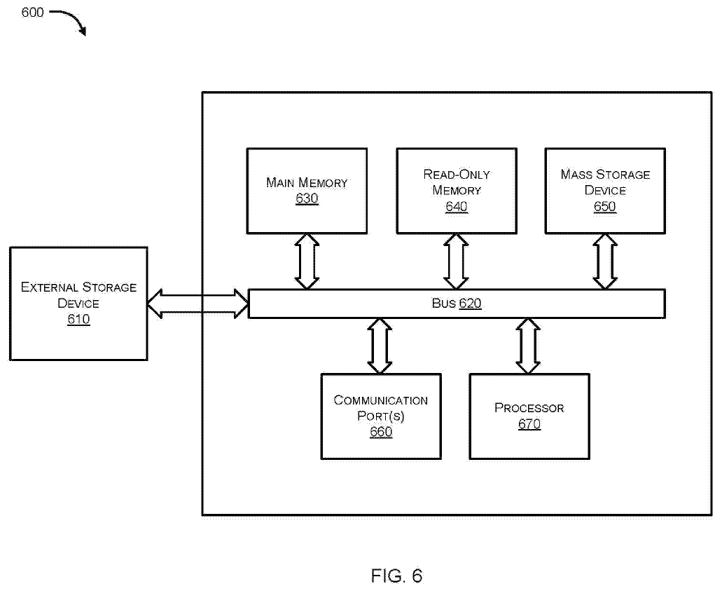

FIG. 5 is a flow diagram 500 illustrating a process of connecting remote client devices to an enterprise network via an authentication client device in accordance with an embodiment of the present invention. The processing described with reference to FIG. 5 may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, this processing may be performed by one or more computer systems of various forms, such as the computer system 600 described with reference to FIG. 6 below.

In the context of the present example, at block 502, a portable hardware-based authentication client device (e.g., authentication client device 110) maintains a list of pre-authorized client devices established by an administrator of an enterprise network (e.g., enterprise network 108). The portable, hardware-based authentication client device is assigned to a particular user of the enterprise network and paired with a VPN appliance (e.g., VPN appliance 112) associated with the enterprise network.

At block 504, the portable, hardware-based authentication client device receives from a client device (e.g., client device 102) via a wired network interface of the portable, hardware-based authentication client device, a connection establishment request for establishing a VPN connection with the enterprise network via the VPN appliance.

At block 506, the portable, hardware-based authentication client device confirms that the connection establishment request was initiated by the particular user by authenticating the particular user. For example, the particular user may authenticate him/herself via a biometric security identification and authentication mechanism (e.g., a finger reader, voice recognition, face recognition, iris or retina recognition, or the like) integrated within the hardware-based authentication client device.

At block 508, when the particular user is successfully authenticated, a further check may be performed to verify whether the client device is on the list of pre-authorized client devices. When the verification is affirmative, at block 510, the portable, hardware-based authentication client device, establishes a tunnel between the portable, hardware-based authentication client device and the VPN appliance.

FIG. 6 illustrates an exemplary computer system 600 in which or with which embodiment of the present invention may be utilized. As shown in FIG. 6, computer system includes an external storage device 610, a bus 620, a main memory 630, a read only memory 640, a mass storage device 650, a communication port 660, and a processor 670. In one embodiment, computer system 600 may represent some portion of an authentication client device (e.g., authentication client device 110 of FIG. 1 and FIG. 2).

Those skilled in the art will appreciate that computer system 600 may include more than one processor 670 and communication ports 660. Examples of processor 670 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 670 may include various modules associated with embodiments of the present invention.

Communication port 660 can be any of an RS-232 port for use with a modem based dialup connection, a 10/100 Ethernet port, a Gigabit or 10 Gigabit port using copper or fiber, a serial port, a parallel port, or other existing or future ports. Communication port 660 may be chosen depending on a network, such a Local Area Network (LAN), Wide Area Network (WAN), or any network to which computer system connects.

Memory 630 can be Random Access Memory (RAM), or any other dynamic storage device commonly known in the art. Read only memory 640 can be any static storage device(s) e.g., but not limited to, a Programmable Read Only Memory (PROM) chips for storing static information e.g. start-up or BIOS instructions for processor 670.

Mass storage 650 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 620 communicatively couples processor(s) 670 with the other memory, storage and communication blocks. Bus 620 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 670 to software system.

Optionally, operator and administrative interfaces, e.g. a display, keyboard, and a cursor control device, may also be coupled to bus 620 to support direct operator interaction with computer system. Other operator and administrative interfaces can be provided through network connections connected through communication port 660. External storage device 610 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A method comprising:
maintaining, by a portable, hardware-based authentication client device, a list of pre-authorized client devices established by an administrator of an enterprise network, wherein the portable, hardware-based authentication client device is assigned to a particular user of the enterprise network and paired with a firewall appliance or a virtual private network (VPN) appliance associated with the enterprise network;
receiving, by the portable, hardware-based authentication client device, from a client device via a network interface of the portable, hardware-based authentication client device, a connection establishment request for establishing a connection with the enterprise network via the firewall appliance or the VPN appliance;
confirming, by the portable, hardware-based authentication client device, the connection establishment request was initiated by the particular user by authenticating the particular user; and
when the particular user is successfully authenticated:
verifying whether the client device is on the list of pre-authorized client devices; and
responsive to said verifying being affirmative and depending upon a location of the portable, hardware-based authentication device, establishing, by the portable, hardware-based authentication client device, a local connection or a VPN tunnel between the portable, hardware-based authentication client device and the firewall appliance or the VPN appliance.

2. The method of claim 1, wherein the portable, hardware-based authentication client device is assigned to a particular user of the enterprise network by issuing a unique token to the portable, hardware-based authentication client device.

3. The method of claim 2, wherein the unique token is used for authentication of the client device.

4. The method of claim 1, wherein the portable, hardware-based authentication client device operates in either a VPN mode or a local mode.

5. The method of claim 1, wherein the portable, hardware-based authentication client device supports one or more types of VPN connections.

6. The method of claim 1, wherein one or more client devices from the list of pre-authorized client devices may establish concurrent connections through the portable, hardware-based authentication to the enterprise network.

7. A non-transitory computer-readable storage medium embodying a set of instructions, which when executed by a processing resource of a portable, hardware-based authentication client device, causes the processing resource to perform a method comprising:
maintaining a list of pre-authorized client devices established by an administrator of an enterprise network, wherein the portable, hardware-based authentication client device is assigned to a particular user of the enterprise network and paired with a firewall appliance associated with the enterprise network;
receiving from a client device via a wired network interface of the portable, hardware-based authentication client device, a connection establishment request for establishing a connection with the enterprise network via the firewall appliance;
confirming the connection establishment request was initiated by the particular user by authenticating the particular user; and
when the particular user is successfully authenticated:
verifying whether the client device is on the list of pre-authorized client devices; and
responsive to said verifying being affirmative, establishing, by the portable, hardware-based authentication client device, a connection between the portable, hardware-based authentication client device and the firewall appliance.

8. The non-transitory computer-readable storage medium of claim 7, wherein the portable, hardware-based authentication client device is assigned to a particular user of the enterprise network by issuing a unique token to the portable, hardware-based authentication client device.

9. The non-transitory computer-readable storage medium of claim 8, wherein the unique token is used for authentication of the client device.

10. The non-transitory computer-readable storage medium of claim 7, wherein the portable, hardware-based authentication client device operates in either a VPN mode or a local mode.

11. The non-transitory computer-readable storage medium of claim 7, wherein the portable, hardware-based authentication client device supports one or more types of VPN connections.

12. The non-transitory computer-readable storage medium of claim 7, wherein one or more client devices from the list of pre-authorized client devices may establish concurrent connections through the portable, hardware-based authentication to the enterprise network.

13. A portable, hardware-based authentication client device comprising:
a processing resource; and
a non-transitory computer-readable medium, coupled to the processing resource, having stored therein instructions that when executed by the processing resource cause the processing resource to perform a method comprising:
maintaining a list of pre-authorized client devices established by an administrator of an enterprise network, wherein the portable, hardware-based authentication client device is assigned to a particular user of the enterprise network and paired with a firewall appliance associated with the enterprise network;
receiving from a client device via a wired network interface of the portable, hardware-based authentication client device, a connection establishment request for establishing a connection with the enterprise network via the firewall appliance;
confirming the connection establishment request was initiated by the particular user by authenticating the particular user; and
when the particular user is successfully authenticated:
verifying whether the client device is on the list of pre-authorized client devices; and
responsive to said verifying being affirmative, establishing, by the portable, hardware-based authentication client device, a connection between the portable, hardware-based authentication client device and the firewall appliance.

14. The portable, hardware-based authentication client device of claim 13, wherein the portable, hardware-based authentication client device is assigned to a particular user of the enterprise network by issuing a unique token to the portable, hardware-based authentication client device.

15. The portable, hardware-based authentication client device of claim 14, wherein the unique token is used for authentication of the client device.

16. The portable, hardware-based authentication client device of claim 14, wherein the portable, hardware-based authentication client device operates in either a VPN mode or a local mode.

17. The portable, hardware-based authentication client device of claim 14, wherein the portable, hardware-based authentication client device supports one or more types of VPN connections.

18. The portable, hardware-based authentication client device of claim 14, wherein one or more client devices from the list of pre-authorized client devices may establish concurrent connections through the portable, hardware-based authentication to the enterprise network.

19. The portable, hardware-based authentication client device of claim 14, wherein the method further comprises:
performing an antivirus scan on the client device; and
when the antivirus scan is indicative of the client device being infected with malware, then protecting the enterprise network from the malware by blocking communication from the client device to the enterprise network.
